(19) United States
(12) Patent Application Publication
(10) Pub. No.: US 2010/0245278 A1
(43) Pub. Date: Sep. 30, 2010

(54) INFORMATION PROCESSING APPARATUS

(75) Inventor: Masakazu HOSODA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/748,204

(22) Filed: Mar. 26, 2010

(30) Foreign Application Priority Data
Mar. 27, 2009 (JP) 2009-80059

(51) Int. Cl. G06F 3/041

(52) U.S. Cl. 345/173

(57) ABSTRACT

An information processing apparatus includes: a main body; an input device provided in the main body and configured to receive operation information generated by an input operation of a user, the operation information comprising information with respect to the number of fingers used in the input operation; an input module provided in the main body; and a processor configured to execute a function corresponding to the number of fingers based on the operation information.

This application is based upon and claims the benefit of priority from Japanese Patent Application No. 2009-080059, filed Mar. 27, 2009, the entire contents of which are incorporated herein by reference.

### BACKGROUND

1. Field

One embodiment of the invention relates to an information processing apparatus in which an input device is incorporated.

2. Description of the Related Art

Conventionally, there are a touch pad, a touch panel, and the like each as an input device which allows an easy input operation. A user touches an operation surface of the touch pad or the touch panel and taps the operation surface with a finger or slides the finger on the operation surface to allow the execution of an operation of selecting items and a movement of a cursor on a display screen.

As the device of this type, there is also known a device which implements a plurality of functions with the number of fingers which perform an instruction input (see JP-A-2008-84158).

In particular, a control unit includes an instruction number detection processing means for detecting the number of fingers performing the instruction input as an instruction number, and a processing execution means for executing processing in correspondence to the instruction number detected by the instruction number detection processing means. It is intended that a user is able to easily perform the input operation by allowing the execution of the instruction using the number of fingers performing the instruction input.

However, in the case of the method described above, the number of plural functions that can be implemented may be limited to the number of fingers.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an external perspective view of a computer according to an exemplary embodiment;

FIG. 2 is a block diagram of the computer according to the embodiment;

FIG. 3 is a view showing functions in correspondence to first and second modes and the number of fingers according to the embodiment;

FIG. 4 is a flow chart showing operation processing according to the embodiment;

FIG. 5 is a flow chart showing first mode processing of FIG. 4;

FIG. 6 is a flow chart showing second mode processing of FIG. 4; and

FIGS. 7A-7D are views showing input operations to an operation surface of an input device and functions according to the embodiment.

### DETAILED DESCRIPTION

Various embodiments according to the invention will be described hereinafter with reference to the accompanying drawings. In general, according to one embodiment of the invention, an information processing apparatus includes: a main body; an input device provided in the main body and configured to receive operation information generated by an input operation of a user, the operation information comprising information with respect to the number of fingers used in the input operation; an input module provided in the main body; and a processor configured to execute a function corresponding to the number of fingers based on the operation information.

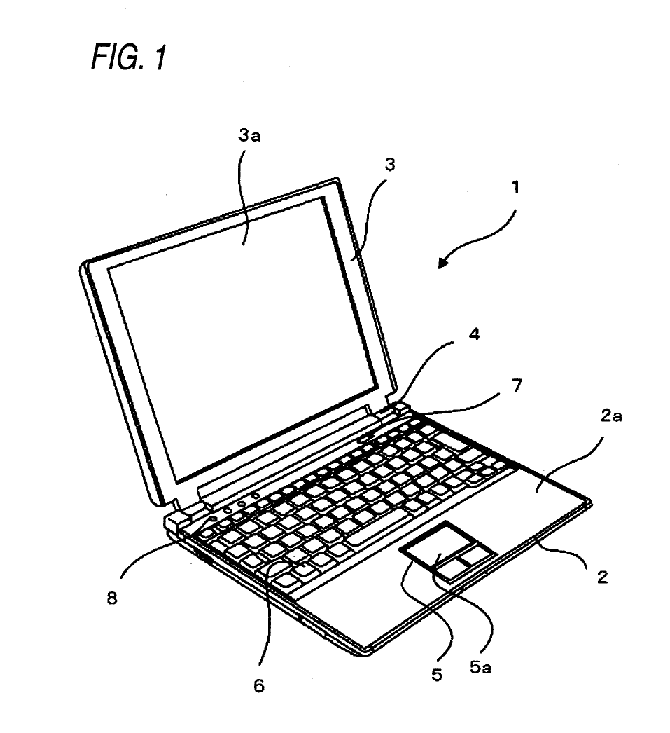

FIG. 1 is an external perspective view showing a computer according to the embodiment of the invention. A computer 1 has a main body cabinet 2, and a display cabinet 3 is pivotably attached to the main body cabinet 2 via a hinge portion 4. The display cabinet 3 is pivotable between an opening position where an upper surface 2a of the main body cabinet 2 is opened and a closing position where the upper surface 2a of the cabinet 2 is covered. A display device 3a composed of a liquid crystal display (LCD) is mounted in the display cabinet 3.

A circuit board on which a plurality of electronic components are mounted, which is not shown, is housed in the main body cabinet 2. To the upper surface 2a of the main body cabinet 2, a touch pad 5 having an operation surface 5a to which a user performs an input operation and a keyboard 6 are attached. The upper surface 2a of the main body cabinet 2 is also provided with a power switch 7 for turning on/off the power supply and a predetermined button 8 which the user can push.

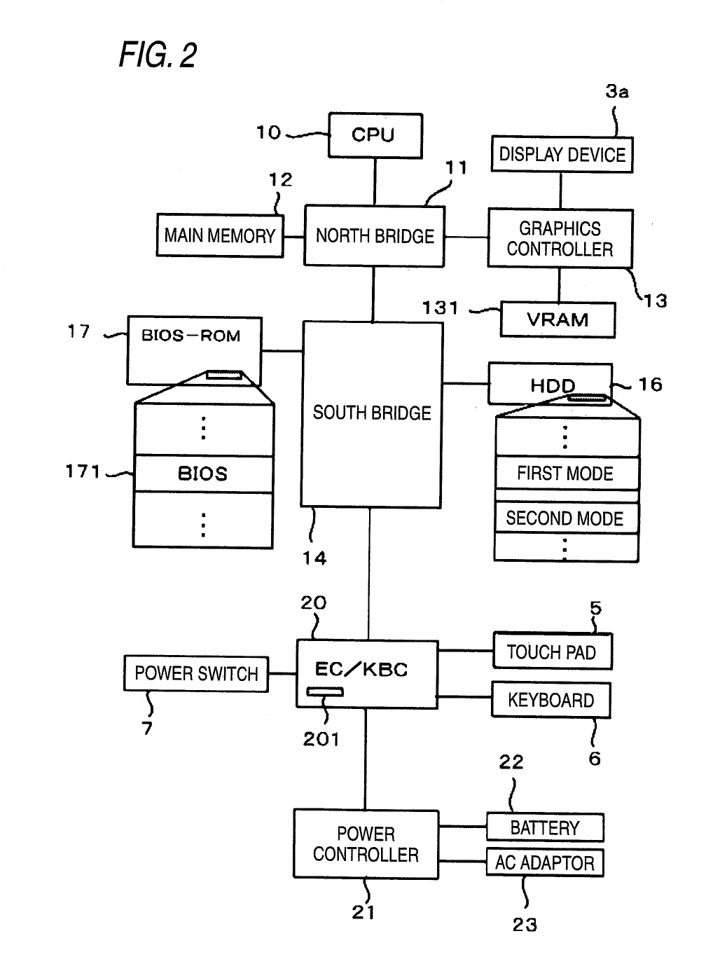

FIG. 2 is a block diagram showing the structure of the computer according to the embodiment of the present invention. In the computer 1, there are provided a CPU 10, a north bridge 11, a main memory (RAM) 12, a graphics controller 13, a south bridge 14, a hard disc drive (HDD) 16, a BIOS-ROM 17, an embedded controller/keyboard controller IC (EC/KBC) 20, the display device 3a, the touch pad 5, the keyboard 6, the power switch 7, and the button 8.

The CPU 10 is a processor for controlling the operations of respective components in the computer 1. The CPU 10 executes an operating system and various application program/utility program which are loaded from the HDD 16 into the main memory (RAM) 12. The main memory (RAM) 12 is also used for storing various data buffers.

In addition, the CPU 10 also executes a BIOS (Basic Input Output System) 171 stored in the BIOS-ROM 17. The BIOS 171 is a program for controlling hardware. The BIOS 171 includes a group of BIOS drivers and, in order to provide a plurality of functions of controlling hardware to the operating system and the application program, each of the BIOS drivers includes a group of function execution routines in correspondence to the functions.

The HDD 16 retains first and second modes which define functions executed in correspondence to the number of fingers and the operation of the key. The BIOS 171 loads the first and second modes stored in the HDD 16 into the main memory, and also executes processing for implementing the functions.

The north bridge 11 is a bridge device for connecting between a local bus of the CPU 10 and the south bridge 14. The north bridge 11 also has a function of executing communication with the graphics controller 13 via a PCI Express bus or the like.

Further, the north bridge 11 has a memory controller for controlling the main memory (RAM) 12 incorporated therein.

The graphics controller 13 is a display controller for controlling the display device 3a used as a display monitor of the present computer 1. The graphics controller 13 sends out a video signal in correspondence to display data written into a video memory (VRAM) 131 by the OS or the application program to the display device 3a.

The south bridge 14 is connected to a peripheral component interconnect (PCI) bus and a low pin count (LPC) bus, and controls a PCI device, a LPC device, and the like. The HDD 16 stores the OS, the various application program/utility program, and a data file. The embedded controller/keyboard controller IC (EC/KBC) 20 is a one-chip microcomputer on which the embedded controller for managing the power supply and the keyboard controller for controlling the touch pad 5 and the keyboard 6 are integrated. The EC/KBC 20 executes power-on/power-off processing of the computer 1 in response to the operation of the power switch 7 by the user in cooperation with a power controller 21. The power controller 21 supplies power to the respective components in the computer 1 by using power from a battery 22 included in the computer 1 or power supplied from the outside via an AC adaptor 23.

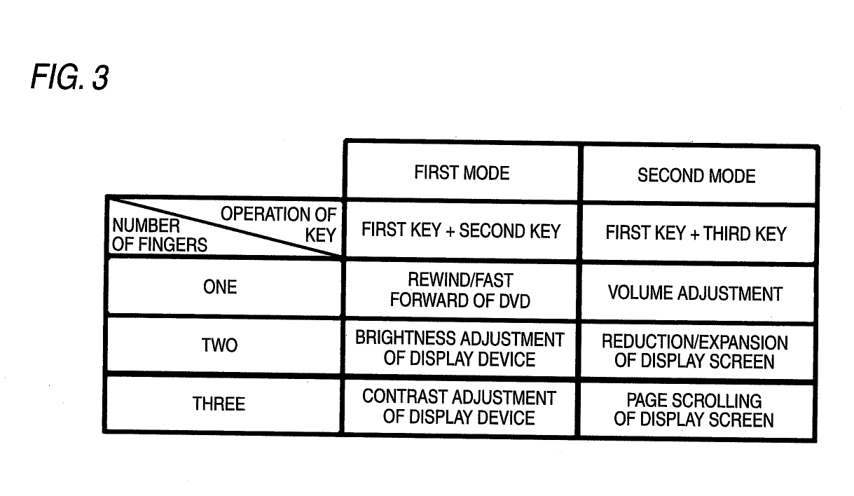

FIG. 3 is a view showing functions in correspondence to the first and second modes and the number of fingers according to the embodiment of the present invention. It is necessary for the user to preliminarily set the allocation of functions in correspondence to the set modes and the number of fingers used when the user operates the touch pad.

The user is capable of setting which function is to be allocated in correspondence to the modes and the number of fingers using the application program by operating the keyboard 6. First, the modes may be set and changed using the combination of the keys inputted from the keyboard 6 by the user, and an arbitrary function may be set and changed with the selection of the number of fingers at the time of input.

FIG. 3 is a view showing which function is allocated in correspondence to the set modes and the number of fingers used when the user operates the touch pad. The first mode is selected with the combination of the first and second keys inputted by the key input of the keyboard 6, or the second mode is selected with the combination of the first and third keys inputted by the key input of the keyboard 6. When the first mode is applied, in correspondence to the number of fingers at the time of input, in a case where the number of fingers is one, the function of rewind/fast forward of a DVD is allocated. Next, in a case where the number of fingers is two, the function of brightness adjustment of the display device is allocated and, in a case where the number of fingers is three, the function of contrast adjustment of the display device is allocated. When the second mode is applied, in a case where the number of fingers at the time of input is one, the function of volume adjustment is allocated. Next, in a case where the number of fingers is two, the function of reduction/expansion of a display screen is allocated and, in a case where the number of fingers is three, the function of page scrolling of the display screen is allocated.

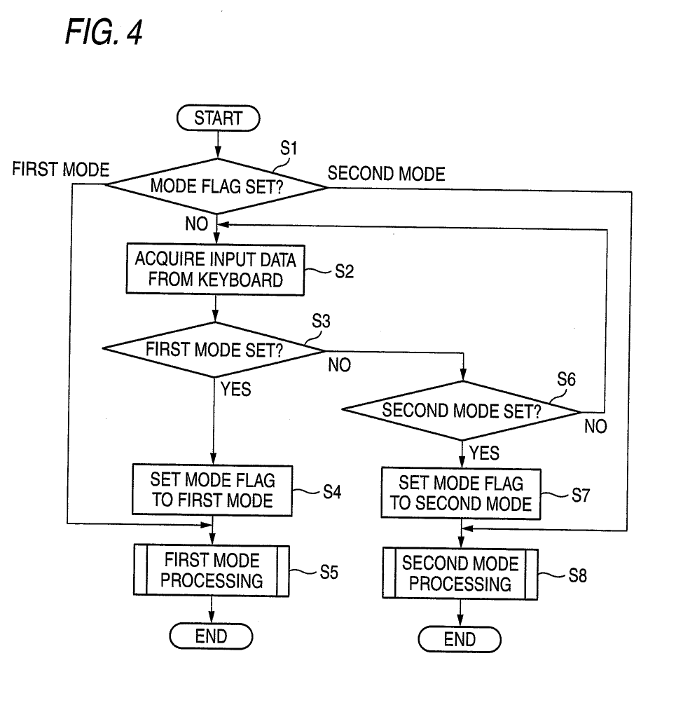

Next, operation processing of the touch pad 5 will be described with reference to flowcharts of FIGS. 4, 5, and 6, and FIGS. 7A-7D.

FIG. 4 is a flow chart showing the operation processing according to the embodiment of the present invention. First, the EC/KBC 20 determines whether or not a mode flag is set by reading a register 201 (step S1). When the mode flag is not set (step S1: No), the EC/KBC 20 receives input data from the keyboard 6 (step S2), and determines whether or not the combination of the keys is the combination indicative of the first mode (step S3). When the input data received from the EC/KBC 20 is equal to the first mode (step S3: Yes), the EC/KBC 20 writes the first mode into the register 201, and the mode flag is set to the first mode (step S4). After the mode flag is set to the first mode, the first mode processing is executed (step S5).

When the input data received from the EC/KBC 20 is not equal to the first mode (step S3: No), the EC/KBC 20 determines whether or not the combination of the keys is the combination indicative of the second mode (step S6). When the input data received from the EC/KBC 20 is equal to the second mode (step S6: Yes), the EC/KBC 20 writes the second mode into the register 201, and the mode flag is set to the second mode (step S7). After the mode flag is set to the second mode, the second mode processing is executed (step S8). Further, when the input data received from the EC/KBC 20 is not equal to the second mode (step S6: No), the EC/KBC 20 returns to receive the input data from the keyboard 6 (step S2).

In the foregoing, the case where the mode flag is not set has been described. On the other hand, when the mode flag is set to the first mode (step S1: first mode), the first mode processing is executed (step S5). When the mode flag is set to the second mode (step S1: second mode), the second mode processing is executed (step S8).

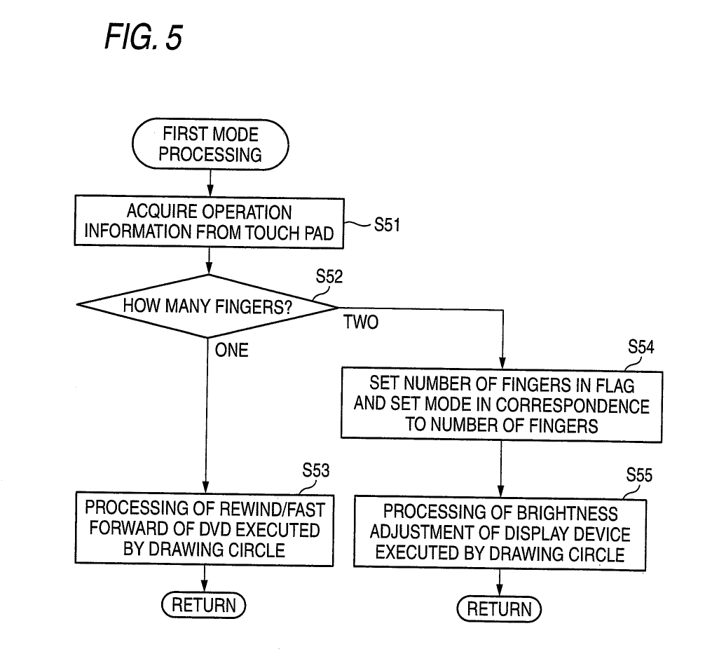

FIG. 5 is a flow chart showing the first mode processing of FIG. 4. The EC/KBC 20 receives operation information from the touch pad 5 (step S51), and determines the number of fingers at the time of input from the operation information (step S52). When it is determined that the number of fingers at the time of input is one from the operation information received from the touch pad 5 (step S52: one), the processing of rewind/fast forward of the DVD is executed by the BIOS 171 in synchronization with the operation of drawing a circle on the operation surface 5a of the touch pad 5 by the user (step S53). When it is determined that the number of fingers at the time of input is two from the operation information received from the touch pad 5 (step S52: two), the number of fingers is set in the flag (step S54), and the processing of the brightness adjustment is executed by the BIOS 171 in synchronization with the operation of drawing a circle on the operation surface 5a of the touch pad 5 by the user irrespective of the number of fingers (step S55). Since the flag of the number of fingers is recorded in a rewritable memory means provided in the EC/KBC 20, it is possible to perform the operation on the operation surface 5a with at least one finger irrespective of the number of plural fingers.

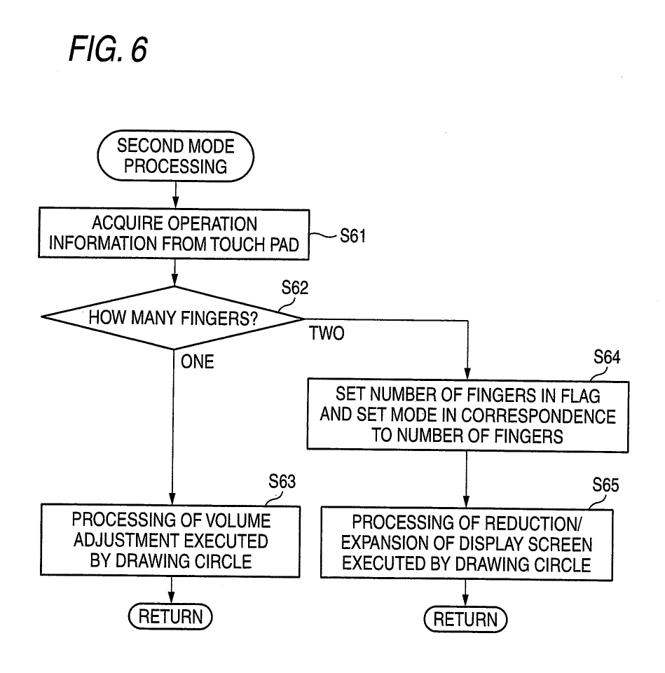

FIG. 6 is a flow chart showing the second mode processing of FIG. 4. The EC/KBC 20 receives the operation information from the touch pad 5 (step S61), and determines the number of fingers at the time of input from the operation information (step S62). When it is determined that the number of fingers at the time of input is one from the operation information received from the touch pad 5 (step S62: one), the processing of the volume adjustment is executed by the BIOS 171 in synchronization with the operation of drawing a circle on the operation surface 5a of the touch pad 5 by the user (step S63). When it is determined that the number of fingers at the time of input is two from the operation information received from the touch pad 5 (step S62: two), the number of fingers is set in the flag (step S64), and the processing of the reduction/expansion of the display screen is executed by the BIOS 171 in synchronization with the operation of drawing a circle on the operation surface 5a of the touch pad 5 by the user irrespective of the number of fingers (step S65).

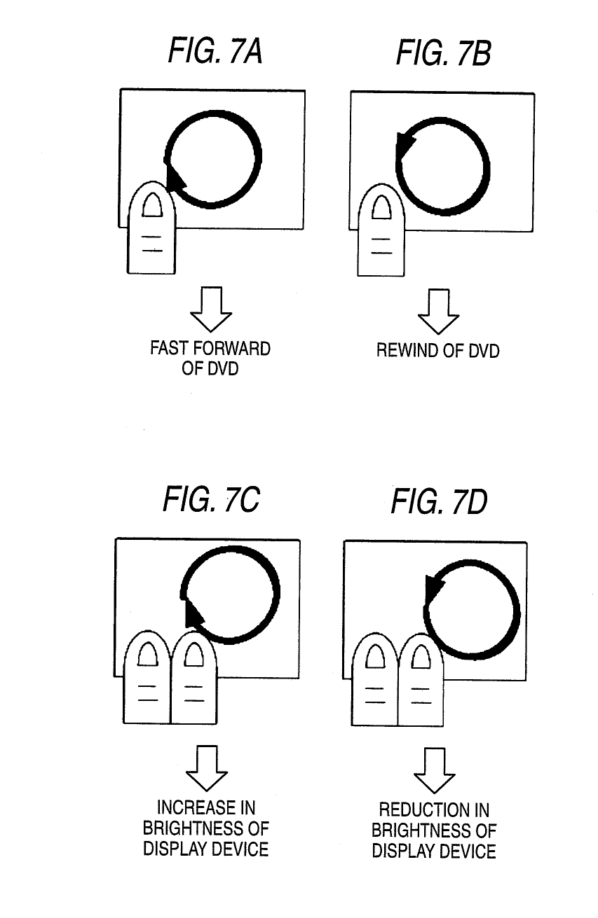

FIGS. 7A-7D are views showing the input operations to the operation surface of the input device and the functions according to the embodiment.

With regard to the processing of the rewind/fast forward of the DVD in synchronization with the operation of drawing a circle in S53 described above, the user continuously draws a circle on the operation surface 5a in a clockwise direction with one finger to allow continuous fast forward of the DVD (FIG. 7A), and the user continuously draws a circle on the operation surface 5a in a counterclockwise direction with one finger to allow continuous rewind of the DVD (FIG. 7B). In addition, with regard to the processing of the brightness adjustment in synchronization with the operation of drawing a circle in S55 described above, the user continuously draws a circle on the operation surface 5a in the clockwise direction with two fingers to allow a continuous increase in the brightness of the display device 3a (FIG. 7C), and the user continuously draws a circle on the operation surface 5a in the counterclockwise direction with two fingers to allow a continuous reduction in the brightness of the display device 3a (FIG. 7D).

In the embodiment of the present invention described above, the description is made on the assumption that the combination of the keys of the keyboard is used when the modes are set. However, a predetermined key, a combination of a plurality of keys, and the predetermined button 8 may also be used.

Thus, according to the embodiment of the present invention, it is possible to provide the information processing apparatus having the number of functions increased by a plurality of modes obtained by combining keys of the keyboard without being limited by the number of fingers.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
an input device in the main body and configured to receive a command entry comprising information with respect to a number of touches used in the command entry;
an input module in the main body; and
a processor configured to execute a function corresponding to the number of touches.

2. The apparatus of claim 1, wherein the input device comprises:
a surface; and
a command entry receiver configured to receive the command entry by continuously drawing a circle with at least one of the touches on the surface.

3. The apparatus of claim 1,
wherein the input module comprises at least one button configured to be depressed.

4. The apparatus of claim 1, further comprising:
a storage configured to store data with respect to the number of touches in the command entry.
